(19) United States
(12) Patent Application Publication
(10) Pub. No.: US 2004/0143819 A1
(43) Pub. Date: Jul. 22, 2004

(54) Generic software testing system and mechanism

(75) Inventors: Fan-Tien Cheng, Tainan City (TW); Chin-Hui Wang, Taipei Hsien (TW); Yu-Chuan Su, Hsin Ying City (TW); Shung-Lun Wu, Tainan City (TW)

Correspondence Address: BAKER & HOSTETLER LLP, Washington Square, Suite 1100, 1050 Connecticut Avenue, N.W., WASHINGTON, DC, 20036, US

(73) Assignee: NATIONAL CHENG KUNG UNIVERSITY

(21) Appl. No.: 10/753,349

(22) Filed: Jan. 9, 2004

(30) Foreign Application Priority Data
Jan. 10, 2003 (TW) 92100574

(51) Int. Cl. G06F 9/44

(52) U.S. Cl. 717/125; 717/133; 717/106

(57) ABSTRACT

A generic software testing system and mechanism is disclosed for use in distributed object-oriented systems. The present invention directly utilizes class diagrams (or interface definitions) and sequence diagrams to automatically generate the execution codes and test template required for testing the software system, wherein the class diagram data, the interface definition data and the sequence diagram data are generated by a software development tool of distributed object-oriented system. The present invention is applicable to the tests of a software system of which the functions and operations can be presented merely with class diagrams (or interface definitions) and sequence diagrams generated by the tools used during software development, wherein the software system can be as small as an individual unit (component) or module, or as large as an entire distributed object-oriented system. The present invention enables the software implementation and the software test planning to be performed at the same time. When the software implementation is done, the software test can be followed immediately to generate test results, so that the functions and performance of the software system can be evaluated.

### FIELD OF THE INVENTION

The present invention relates to generic software testing system and mechanism, and more particularly, to the generic software testing system and mechanism which can perform both implementation and test planning simultaneously for a software unit/system in a distributed object-oriented system.

### BACKGROUND OF THE INVENTION

A common procedure for developing software mainly includes five stages: requirement analysis, object-oriented analysis (OOA), object-oriented design (OOD), system implementation, and system integration and test, wherein the major mission for the stage of system integration and test is to conduct the system integration and then to test the system integrated, thereby evaluating if the software programs finished at the stage of system implementation have met the system requirements. If the test results are not quite satisfying, system developers have to return back to the stage of OOA, and then make some necessary modifications in accordance with the development procedures.

However, the repetitive test and modification procedures described above often consume a lot of time and effort. Testing engineers usually spend a lot of time to communicate with programmers for understanding the contents of the system implemented, and generally cannot start to write test plans and test codes until the system implementation has been done, thus further delaying the completion of software development. Hence, in order to simplify and perform the test work as early as possible, it is necessary to let the testing engineers fully understand the contents of the system under test without spending too much time on the communication with the programmers; and, to allow the testing engineers to write the test plans and testing programs at the same time while the software program is made during the stage of the system implementation, so that right after the fabrication of the software program is done, the software program can be tested immediately to generate the test results for evaluating the correctness and performance of the functions of the software.

In the existing patent applications, U.S. Pat. No. 6,421,822, applied in fabrication industries, provides a method for generating test codes for an automatic procedure, wherein this patent utilizes the database of the object under test to conduct a test; U.S. Pat. No. 6,353,897, applied in software development, provides a method for testing object oriented software, wherein the method includes a software test framework that includes one or more test drivers and one or more test cases for each test driver, and each test case can also have multiple variations, so that a programmer can base on the required cases to conduct a test without a skillful testing engineer; U.S. Pat. No. 5,781,720, applied in GUI (Graphic User Interface) testing, provides a method for user interfaces, wherein user input actions to GUI are simulated to test the response of GUI; U.S. Pat. No. 5,794,043, applied in testing classes of an object oriented program, provides a tester to test the function of each method call of the classes, and the output results of each method call are checked in accordance with the parameters inputted to the tester; U.S. Pat. No. 6,182,245, applied in software testing, discloses a method for testing a software program, wherein a test case database is provided at a server for a client to use for conducting the software program, and a test case server is used for storing and managing test case data; U.S. Pat. No. 6,163,805, applied in internet hardware/software testing, discloses a method providing a user to conduct a hardware/software test by using internet, wherein a user interface is utilized for the user to select testing parameters, and the test data packet is passed to the user's computer; U.S. Pat. No. 5,799,266, applied in software testing, provides a method for testing functions by using a test driver generator to generate test drivers, wherein the method is to input the functions' parameters and execution sequence into the test driver generator, and to conduct the test via the test drivers. However, the aforementioned patents provides methods or apparatuses towards the features of individual applications, and lack of generic applicability; fails to simplify the communication between testing engineers and programmers; and further have the difficulty of simultaneously performing system implementation and writing test plans and test codes.

On the other hand, presently, there are several scholars conducting the applicability researches on applying the design models of UML (United Model Language) in testing activities, those researches including: Chevalley (P. Chevalley, “Automated Generation of Statistical Test Cases from UML State Diagram,” in Proc. 25th Annual International Computer Software and Applications Conference, Chicago, U.S.A., pp.205-214, October 2001.) used the probability concept to design a functional testing method for conducting a test, wherein the method defines an automatic theory for automatically generating test cases for the test purpose via UML state diagrams; Jean Hartmann et al. (J. Hartmann, C. Imoberdorf, and M. Meisinger, “UML-Based Integration Testing,” in Proc. 2000 ACM International Symposium on Software Testing and Analysis, Volume 25, Issue 5, Portland, U.S.A., pp.60-70, September 2000.) disclosed that: in order to conduct a test by using state diagrams, one set of communication semantic has to be first selected, and then a global behavior model depicting the entire system is established after the state diagrams of the individual components are undergone a standardization treatment by using the aforementioned communication semantic, and thereafter the test cases required for an integrated test are found from the global behavior model so as to conduct a test; Y.-G. Kim et al. (Y.-G. Kim, H.-S. Hong, D.-H. Bae, and S.-D. Cha, “Test Cases Generation from UML State Diagrams,” in 1999 Software, EE Proceedings-, Volume 146, Issue 4, pp.187-192, August 1999.) provided a related method with reference to path testing in the conventional testing theory, wherein the data flow and control flow found from state diagrams are utilized for conducting a test. The aforementioned researches are commonly focused on how to use state diagrams and to refer to possible state changes of objects for generating test cases. In the definition of UML, state diagrams are used for displaying a series of state changes in response to events from a certain object or class during its life cycle, and the purpose thereof is to emphasize the control flow between states. With regard to one single object or class, the test cases can be generated via the state diagrams for conducting a test. However, the interactive relationships among objects, or the information flow processes among objects in a system, can be described by the state diagrams. Hence, although the aforementioned testing schemes can be used to conduct a test for one single class or object, yet they cannot be used to support an integrated system test required by a distributed system.

Hence, there is an urgent need to develop generic software testing system and mechanism for use in a distributed object-oriented system, thereby simplifying the communication between a testing engineer and a programmer; having generic applicability, so that the targets as small as one single element or module, or as large as the entire distributed object-oriented system are all suitably applied; simultaneously performing system implementation and writing test codes, so as to promote the efficiency of software development and lower the development cost.

### SUMMARY OF THE INVENTION

In view of the aforementioned background, the conventional software testing technology lacks of generic applicability; cannot simplify the communication between testing engineers and programmers; is difficult for simultaneously performing system implementation and writing test plans and test codes; and cannot support a system integration test required by a distributed system.

Hence, a main object of the present invention is to provide generic software testing system used for simultaneously performing system implementation and writing test plans and test codes, so that the test work can be performed immediately after the implementation of the system under test is done, thereby shortening the development life cycle of the entire software, thus achieving the purpose of promoting production efficiency.

Another object of the present invention is to provide generic software testing system and mechanism for use in various distributed object-oriented software and system integration industries, thereby lowering the test cost and promoting the overall development efficiency.

Still another object of the present invention is to provide generic software testing system and mechanism used for performing functional and non-functional system tests.

According to the aforementioned objects, the present invention provides a generic software testing system for a distributed object-oriented system to perform a test, wherein the generic software testing system comprises: a test-plan wizard, generating test-plan execution codes and a test-result template in accordance with class-diagram related data and sequence-diagram related data; a tested software unit/system, executing the aforementioned test plan execution codes to generate a test result; and a comparator, comparing the aforementioned test result with the aforementioned test-result template to generate a test report.

Further, the present invention provides a generic software testing mechanism for a distributed object-oriented system to perform a test. In the generic software testing mechanism, class-diagram related data is inputted to a test-plan wizard as a basis of the test, and then a testing sequence diagram is selected from sequence-diagram related data for use in the test, and the data of the testing sequence diagram is inputted to the test-plan wizard. Thereafter, a plurality of reference input values and a plurality of output values are filled with respect to the testing sequence diagram, and a test-result template containing the reference input values and the reference output values is generated by the test-plan wizard, and then the test-result template is passed to a comparator. Meanwhile, the test-plan wizard generates test-plan execution codes, and a tested software unit/system executes the aforementioned test-plan execution codes for performing the test to generate a test result, and then the test result is passed to the comparator. Thereafter, the comparator creates a test report.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing the functions and flow chart of generic software testing system and mechanism of the present invention;

FIG. 2 is a schematic diagram showing the use cases of generic software testing system and mechanism of the present invention;

FIG. 3 is the functional block diagram of the test-plan wizard of the present invention;

FIG. 4 is a diagram showing the documental structure of a class diagram parsed by the present invention;

FIG. 5 is a diagram showing the documental structure of a sequence diagram parsed by the present invention;

FIG. 6 is the class diagram of an illustrative example in an object-oriented design stage, according to a preferred embodiment of the present invention;

FIG. 7 is the sequence diagram of an illustrative example in an object-oriented design stage, according to the preferred embodiment of the present invention;

FIG. 8 is a schematic diagram showing a procedure for parsing a file with an extension name “mdl” with a class diagram parser, according to the preferred embodiment of the present invention;

FIG. 9 is a schematic diagram showing a procedure for parsing a file with an extension name “mdl” with a sequence diagram parser, according to the preferred embodiment of the present invention;

FIG. 10 is a schematic diagram showing a test-result template containing reference input/output values of an illustrative example, according to the preferred embodiment of the present invention; and

FIG. 11 is a schematic diagram showing a test result of an illustrative example, according to the preferred embodiment of the present invention.

### DETAILED DESCRIPTION OF THE PREFERRED EMBODIMENT

When an object-oriented design stage is completed, class diagrams and sequence diagrams are generated for the software to be fabricated, and the class diagrams and the sequence diagrams are mainly used for providing sufficient information to programmers for performing software implementation. Just as described above, in the conventional technology, tests often cannot start preparing test plans and testing execution files until the software implementation is done, thus wasting a lot of time and causing the increase of production cost.

The information contained in class diagrams and sequence diagrams is actually sufficient for testing engineers to make test plans and testing execution files. Hence, the present invention is mainly featured in: allowing testing engineers and programmers to use the class diagrams and sequence diagrams, so that while the programmers are performing software implementation, the steps of making test plans/testing execution files can be performed at the same time. Therefore, when the software implementation is done, the test plans and the testing execution files are also ready, so that each module of the implemented system under test can be tested immediately so as to generate a test result, thereby evaluating the functional accuracy and performance for each module or the entire system.

The present invention satisfies demands regarding the software testing procedure with respect to a distributed system using an object-oriented development procedure as the software development standard, wherein generic software testing system and mechanism are designed via the properties of Unified Modeling Language (UML) used in the object-oriented development procedure, thereby assisting testing engineers to perform testing activities.

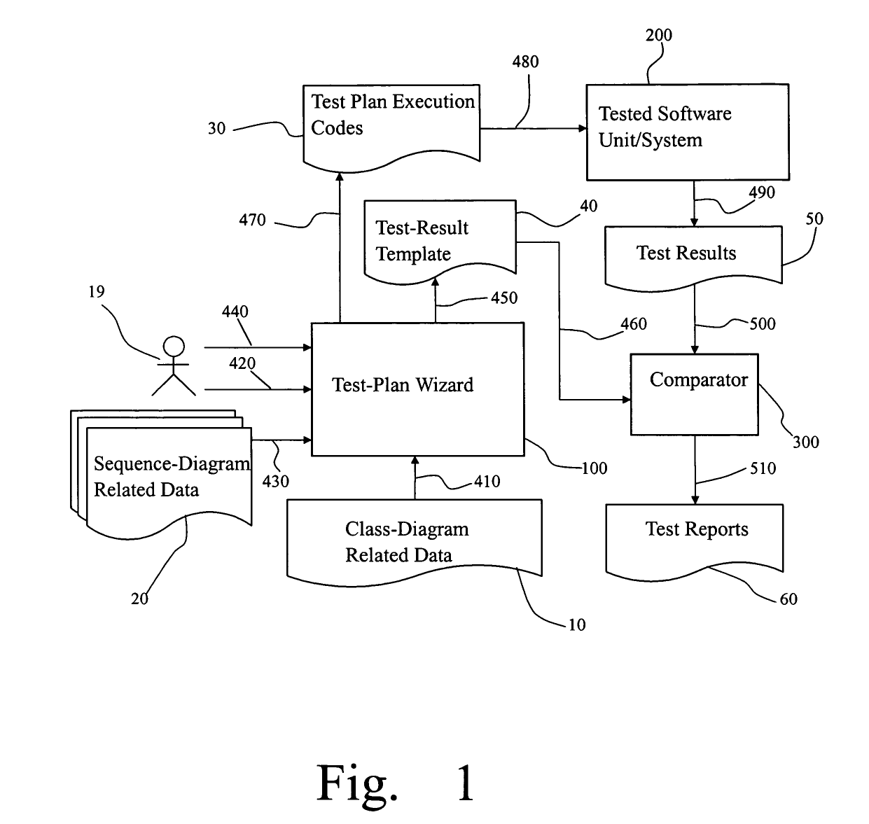

Referring to FIG. 1, FIG. 1 is a schematic diagram showing the functions and flow chart of generic software testing system and mechanism of the present invention. The generic software testing system of the present invention is mainly composed of a test-plan wizard 100, a tested software unit/system 200 and a comparator 300, thereby providing a testing engineer 19 to edit a test plan and to generate a test-result template 40 for the respective objectives of a module functional test or a system integration test by using class-diagram related data 10 as a basis; and adapting sequence-diagram related data 20 as a script. The test-plan wizard 100 also uses inputs provided from a testing engineer 19 to generate test-pan execution codes 30. Thereafter, the tested software unit/system 200 uses the test-plan execution codes 30 to perform a software test and generates a test result 50. Then, the test result 50 and the expected values in the test-result template 40 are inputted to a comparator 300, thereby making comparison to generate a test report 60.

Please refer to FIG. 1 continuously, and each component is explained in detail as follows:

(1) The class-diagram related data 10 comprises a plurality of designed class diagrams used as a major basis for the test-plan wizard 100 to design the test plan for the tested system. If the integration test of the distributed system is to be performed, the I/O interface definition for each module in the tested system also has to be inputted.

(2) The sequence-diagram related data 20 comprises a plurality of designed sequence diagrams used as a major basis for the test-plan wizard 100 to design the test plan for the tested system. The sequence diagrams are first divided into several scenarios with proper lengths, and then a test is performed in sequence.

(3) The test-plan wizard 100 is a core mechanism of the present invention, and is used for converting the information in the class-diagram related data 10 and the sequence-diagram related data 20 to the test-plan execution codes 30 and the standard test-result template 40 used for comparing with the test output.

(4) The test-result template 40 includes a set of standard reference values generated by the test-plan wizard 100, and these standard reference values are used for comparing with the test result 50 generated by using the test-plan execution codes 30 to test the software under test.

(5) The test-plan execution codes 30 are generated by the test-plan wizard 100 in accordance with the class-diagram related data 10 and the sequence-diagram related data 20 for testing the software under test.

(6) The tested software unit/system 200 is used for executing the test-plan execution codes 30 to perform the test so as to generate the test result 50.

(7) Actual test result values are stored in the test result 50, and are used for comparing with the standard reference values in the test-result template 40.

(8) The comparator 300 is used for comparing the standard reference values stored in the test-result template 40 with the actual test result values stored in the test result 50, so as to generate the test report 60.

(9) The test report 60 is used for providing the testing engineer 19 a software test report.

Please refer to FIG. 1 continuously, and the execution procedure of each step is described as follows:

At first, such as shown in step 410, the class-diagram related data 10 is inputted as a basis for test. After the testing engineer 19 selects a testing sequence diagram for testing use (step 420), step 430 is performed for inputting the sequence-diagram related data 20 required. Then, the testing engineer 19 fills in reference input values and reference output values in accordance with the testing sequence diagram (step 440). Thereafter, such as shown in step 450, the test-plan wizard 100 generates the test-result template 40 containing the reference input values and the reference output values in accordance with the class-diagram related data, the sequence-diagram related data, the reference input values and the reference output values. Then, step 460 is performed for passing the test-result template 40 to the comparator 300. Meanwhile, such as shown in step 470, the test-plan wizard 100 generates the test-plan execution codes in accordance with the class-diagram related data 10 and the sequence-diagram related data 20.

Thereafter, a tested software unit/system 200 performs a test with the test-plan execution codes 30 to generate the test result 50 (step 490), wherein the test can be a software unit test or a software system test, and the test result 50 including the data such as test schedule records, actual output values and error messages, etc. Then, such as shown in step 500, the test result 50 is passed to the comparator 300, so as to perform the comparison between the actual output values and the reference output values sent from the test-result template 40 (step 460). Thereafter, a test report 60 is generated in accordance with the comparison result (step 510).

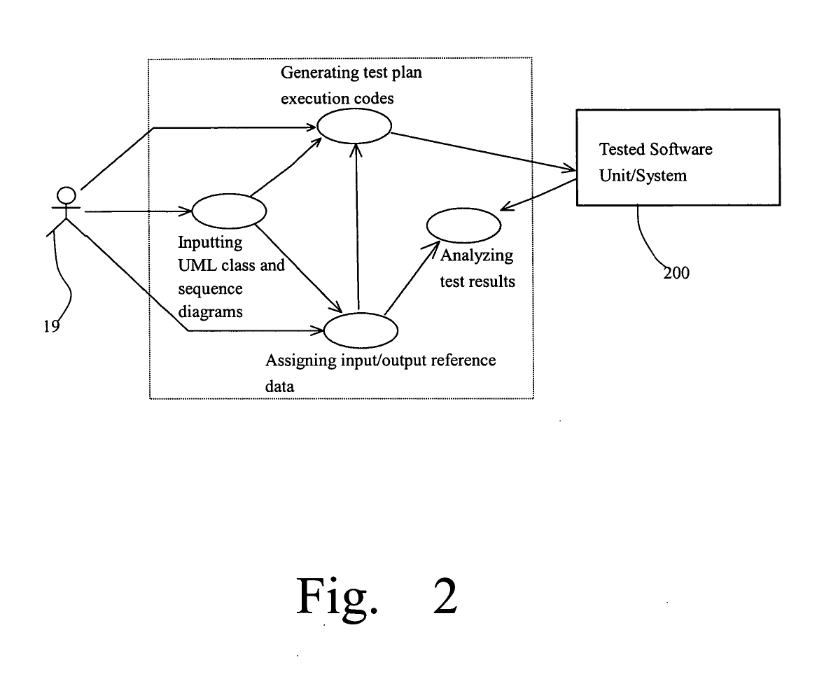

Referring to FIG. 2, FIG. 2 is a schematic diagram showing the use cases of generic software testing system and mechanism of the present invention. According to the fundamental requirements and functional analysis of the aforementioned generic software testing system and mechanism, such as shown in FIG. 2, the actor interacting with the generic software testing system and mechanism of the present invention is the testing engineer 19, i.e. the one operating the generic software testing system of the present invention; and the tested software unit/system 200 is the software unit/system under test. The use cases contained in the generic software testing system and mechanism of the present invention are: inputting UML class diagrams and sequence diagrams; assigning input/output reference data; generating test-plan execution codes; and analyzing test results.

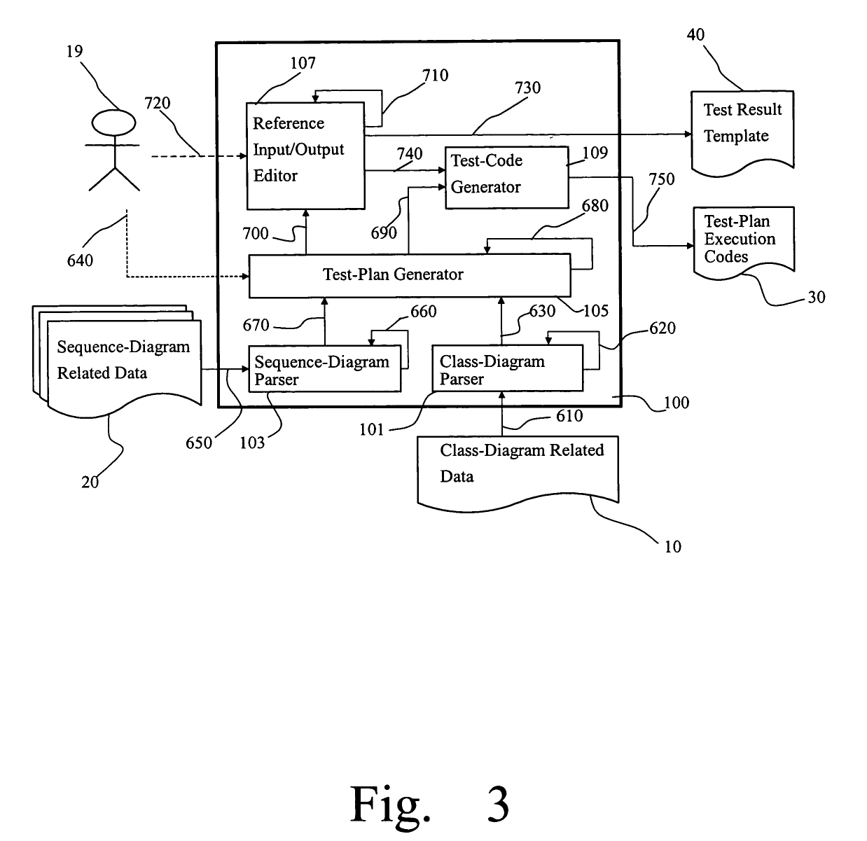

Referring to FIG. 1 and FIG. 3, FIG. 3 is the functional block diagram of the test-plan wizard of the present invention. The mechanism of the function for each use case will be described in detail hereinafter in accordance with FIG. 1 and FIG. 3. (1) Inputting UML Class Diagrams and Sequence Diagrams

Currently, the most commonly-used UML editor software is the Rational Rose development tool developed by Rational Software Corporation, which provides a visualized graphic interface for users to perform OOA and OOD jobs in accordance with UML specifications. Rational Rose also saves the edited result into a text file with the extension name “mdl”.

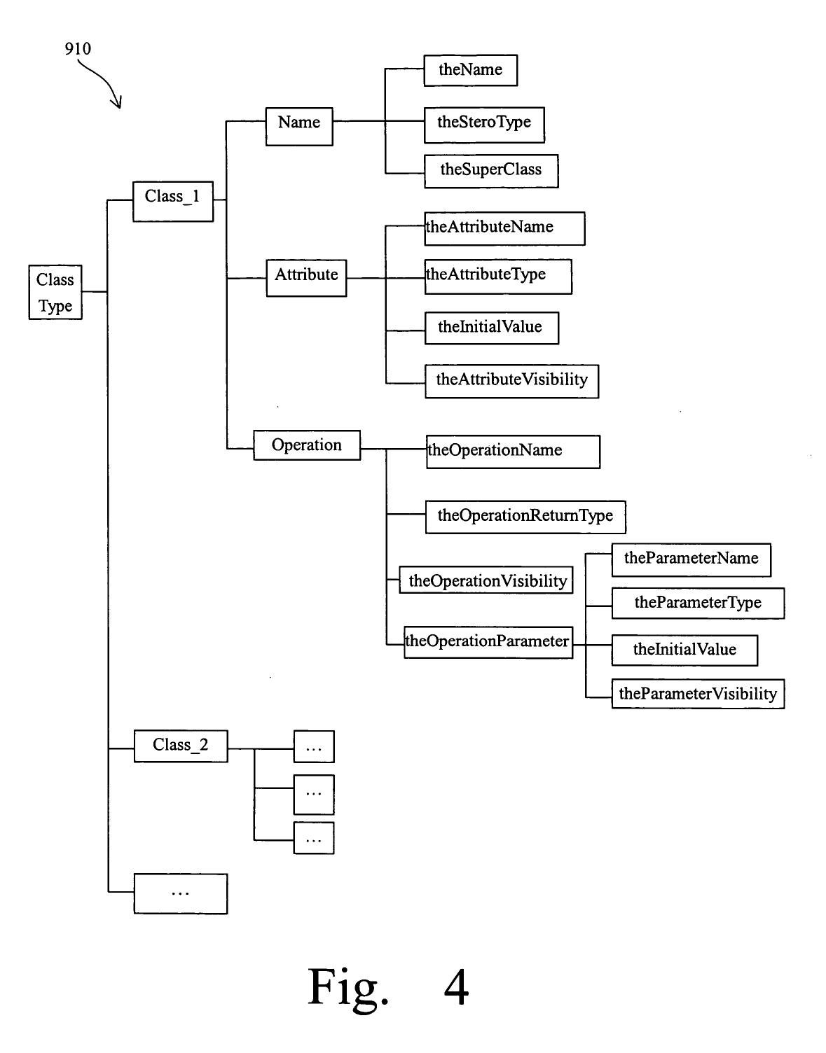

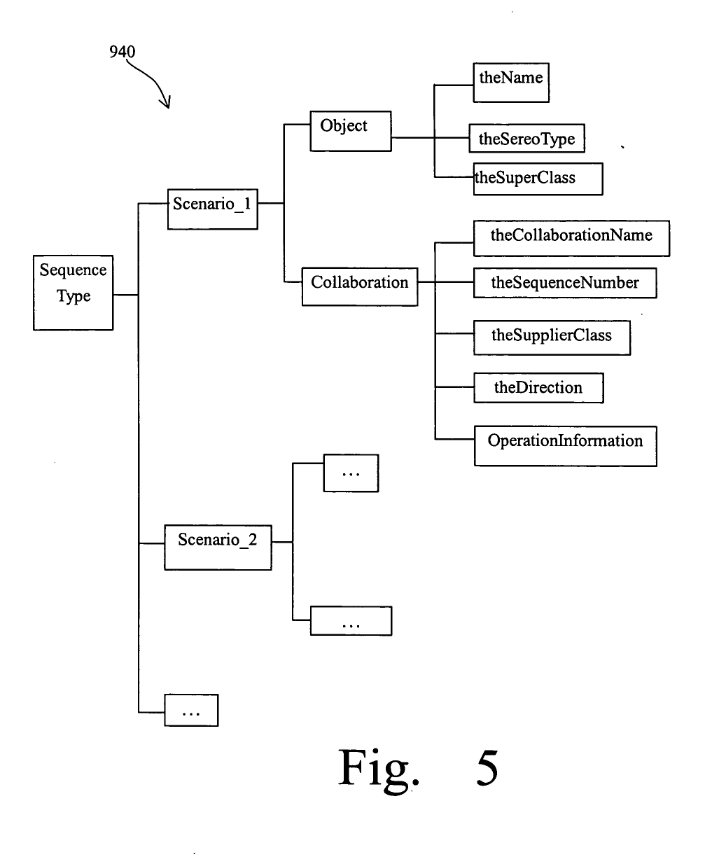

Referring to FIG. 4 and FIG. 5, FIG. 4 is a diagram showing the documental structure of a class diagram parsed by the present invention, and FIG. 5 is a diagram showing the documental structure of a sequence diagram parsed by the present invention. For integrating the generic software testing system of the present invention with a relatively popular UML editor software to achieve the purpose of generic application, the present invention obtains a class-diagram document structure 910 (such as shown in FIG. 4) and a sequence-diagram document structure 940 (such as shown in FIG. 5) by referring to UML standards published by OMG (Object Management Group). Referring to FIG. 3, according to the aforementioned two document structures (class-diagram and sequence-diagram document structures), the present invention designs a class-diagram parser 101 and a sequence-diagram parser 103 for UML documents in accordance with the different editor software to be supported (such as Rational Rose or other editor software supporting UML). Therefore, the testing engineer 19 can input the class-diagram related data 10 and the sequence-diagram related data 20 to the test-plan wizard 100 for analysis, and also obtain the required data for use in the subsequent jobs. Hereinafter, an example supporting Rational Rose is used for explaining the class-diagram parser and the sequence-diagram parser.

(a) Process for Parsing Class Diagrams

Such as shown in FIG. 3, with respect to extracting the class diagrams, the testing engineer 19 first inputs the data located in the class-diagram position of the .mdl file to the class-diagram parser 101 (step 610), thereby establishing all the class data with regard to .mdl file. Thereafter, the class-diagram parser 101 performs step 620 for parsing class diagrams. Such as shown in FIG. 4, with respect to one single class, a class number is first parsed out from the class-diagram related data 10 as shown in FIG. 3, and is filled in field “Class_N”. Thereafter, under the “Name” field of the class, class name (field “theName”), class stereotype (field “theStereoType”) and super class (field “theSuperClass”) are extracted, and then class attribute (field “Attribute”) is extracted, including: attribute name (field “theAttributeName”), attribute type (field “theAttributeType”), initial value (field “theInitialValue”) and attribute visibility (field “theAttributeVisibility”). After completing parsing all the information of class attributes, the data of “Operations” is parsed subsequently, including: operation name (field “theOperationName”), operation return type (field “theOperationReturnType”), operation visibility (field “theOperationVisibility”) and operation parameters (field “theOperationParameter”), wherein the operation parameters further include: parameter name (field “theParameterName”), parameter type (field “theParameterType”), initial value (field “theInitialValue”) and parameter visibility (field “theParameterVisibility”). According to the aforementioned procedure, the class-diagram document structure (such as shown in FIG. 4) can be obtained after all the classes concerned are parsed.

(b) Process for Parsing Sequence Diagrams

Such as shown in FIG. 3, with respect to extracting the sequence diagrams, the names of all the sequence diagrams in the .mdl file are first displayed, so that the testing engineer 19 can select one or more testing sequence diagrams that are related together to be the test entity, and also input the testing sequence diagrams to a test-plan generator 105 (step 640) for performing a test. After the data located in the sequence-diagram position of the .mdl file is inputted to the sequence-diagram parser 103 (step 650), step 660 is performed for parsing sequence diagrams. Hereinafter, the parsing procedure is explained by using only one single sequence diagram, but the present invention is not limited thereto.

Such as shown in FIG. 5, scenario numbers are first parsed out from the sequence-diagram related data 20 as shown in FIG. 3, and is filled in field “Sequence_N”. Thereafter, according to the scenario numbers, the objects used in each scenario are parsed out, and then each object's name (field “theName”), stereotype (field “theStereoType”) and super class (field “theSuperClass”) are extracted, and then the collaborative relationships of the objects, namely collaborations (field “Collaboration”), are parsed. Each collaboration of the object includes a collaboration name (field “theCollabrationName”, a sequence number (field “theSequenceNumber”), a supplier class (field “theSupplerClass”), a direction of the collaboration (field “theDirection”) and operation information (field “OperationInformation”), wherein the direction of the collaboration may start from client to supplier or from supplier to client (note: the object itself is defined as the client). Because the collaboration is actually an operation to an object or a class of the supplier, only the class name and the operation name of the supplier class have to be known for the present invention. If detailed operation information of the supplier class is needed, then the operation information, such as operation name (field “theOperationName”), operation return type (field “theOperationReturnType”), and operation visibility (field “theOperationVisibiliy”), can be obtained by merely referring to the operation parameters field (field “Operation”) in the class-diagram document structure (such as shown in FIG. 4).

Generally, a sequence diagram can be used to describe one or more scenarios for one event, and each scenario may be composed of more than one step. One or several related steps are grouped to become a scenario. Once the parameters of a certain scenario are assigned and initiated, then the steps in this scenario will be continuously executed in sequence until all the outputs are generated. Therefore, test plans shall be designed based on each scenario, and the sequence-diagram parser 103 shall be able to identify all the scenarios in a sequence diagram. Please refer to FIG. 3 again. After the information related to class diagrams and sequence diagrams is obtained, the class-diagram parser 101 passes the parsed class-diagram information to the test-plan generator 105 (step 630), and the sequence-diagram parser 103 passes the parsed sequence-diagram information to the test-plan generator (step 670). The reference input/output values are edited in the subsequent stage in accordance with the class diagrams and the sequence diagrams.

(2) Assigning Input/Output Reference Data

The test-plan generator 105 performs a job for editing information (step 680) in accordance with each sequence diagram and the scenarios thereof to design test plans, wherein each sequence diagram is corresponding to a test plan and each scenario is a test case. Then, the contents of the test plans generated are passed to a reference I/O editor 107 for treatment (step 700). According to the contents of the test plans, the reference I/O editor 107 finds the classes related to the test plans and refer to the operation information required by the classes, thereby generating an input/output interface template (step 710), and then asks the testing engineer 19 to key in reference input values (and operation parameters) and reference output values (i.e. the expected return values) (step 720).

For assuring the specific test programs to be executed smoothly, after the testing engineer 19 inputs all the data, the reference I/O editor 107 validates all the data values according to the data types and constraints required. If an input value does not match the data type and/or constraint required (for example, an integer is required, but a string is entered instead), then the testing engineer 19 will be requested to re-enter the input value. Finally, the reference input values are passed to the test-code generator 109 (Step 740) to generate the test-plan execution codes 30 (step 750). Meanwhile, the associated test-result template 40 including the information about the testing steps and reference I/O values is established by the reference I/O editor 107 (step 730), and is used for comparing with the actual test results obtained in the later step.

(3) Generating Test-Plan Execution Codes 30

After the test-plan generator 105 decides which information flow (scenario) is to be tested, the test-plan generator 105 passes the related information about the scenario to the test-code generator 109 (step 690) for the preparation of generating the test-plan execution codes. After receiving the reference inputs from the reference I/O editor 107 (Step 740), the test-code generator 109 begins to generate the corresponding test-plan execution codes 30 (step 750) for performing an actual test.

(4) Analyzing Test Results

With the test-result template 40 containing the information about the testing steps and the reference I/O values, and the test result 50 generated by executing the test-plan execution codes 30, the comparator 300 (such as shown in FIG. 1) can compare the reference output values with the actual output values to generate the test report 60.

It is worthy to be noted that the present invention can be suitable for use in a software unit test and a software system integration test with respect to different levels of a distributed system software. For the software unit test, the testing target is the class diagram inside the software unit, and the testing script is the sequence diagram depicting the dynamic behavior of the software unit. For the software system integration test, the testing target is the I/O interface definition of each software unit, and the testing script is the sequence diagram depicting the communication structure among the software units. If a software module is considered as an object, then the interface definition diagram of the software module is similar to the class diagram. Further, if the distributed system uses CORBA (Common Object Request Broker Architecture) as its communication infrastructure, then an IDL (Interface Definition Language) file used for showing the interface definition of each software module is equivalent to the .mdl file in the class diagram. Hence, by merely using UML as a tool for depicting the class diagrams and sequence diagrams of the objects on various system levels, the generic software testing system and mechanism of the present invention can be applied to the functional and non-functional tests for the target as small as a software unit and that as large as the entire object-oriented system.

Hereinafter, a preferred embodiment having a three-tiered structure is used to further explain the present invention.

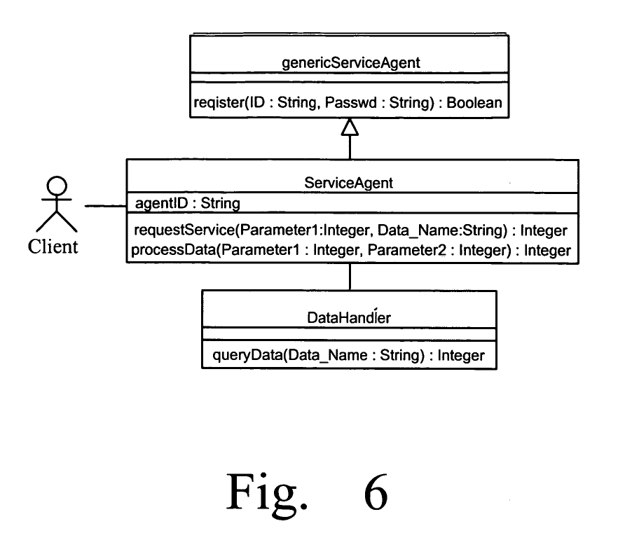

Referring to FIG. 6, FIG. 6 is the class diagram of an illustrative example in an object-oriented design stage, according to a preferred embodiment of the present invention. In the class diagram, an actor (i.e. a client) and three classes are designed, and the classes are: genericServiceAgent, ServiceAgent, and DataHandler, wherein the client is the client-side that requests services, and the genericSercviceAgent is responsible for defining the basic functions to provide services required by general server-side components which are receiving calls. For example, when the client-side proposes a service request to the server-side, the server-side will ask the client-side to register in advance. The ServiceAgent inherits the attributes and functions from the genericServiceAgent and is able to provide the server-side's functions. The DataHandler gets data from database and sends it to the ServiceAgent as requested.

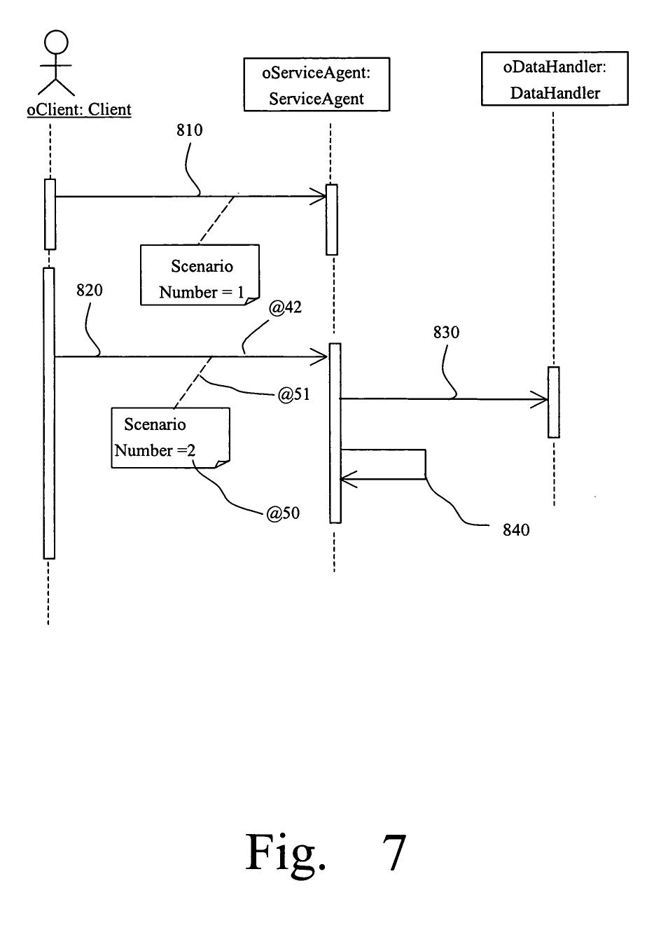

Referring to FIG. 7, FIG. 7 is the sequence diagram of an illustrative example in an object-oriented design stage, according to the preferred embodiment of the present invention. The entire sequence diagram has four steps, which are divided into two scenarios. The division of the scenarios is based on the functions of the program to be tested. One sequence diagram can be divided into one or several scenarios to be tested, and each scenario is composed of one or several steps, and the steps are sequentially planned into the scenario for testing. With respect to the present embodiment, when the client-side requests a service from the sever-side, at first, the client-side has to submit a service registration request to the ServiceAgent of the sever-side, namely invoking register( ) in the ServiceAgent (step 810), and the client-side cannot request a service from the ServiceAgent until the registration succeeds, so that step 810 is classified as the first scenario (i.e. Scenario Number=1). After successful registration, the client-side can request a service from the ServiceAgent, namely calling requestService( ) in the ServiceAgent. The ServiceAgent executes the requestService( ) (step 820), and gets the necessary information from a data handler by invoking queryData( ) (step 830). After receiving replied information, the ServiceAgent executes processData( ) to provide the service requested by the client-side (step 840). These steps 820, 830, and 840 constitute a service function for replying the request from the client-side, and thus are classified as the second scenario (i.e. Scenario Number=2) used for testing the service function.

The steps for building the test plans of the present embodiment are described as follows:

Step 1: Inputting UML Class Diagrams and Sequence Diagrams

(a) Process for Extracting Class Diagrams

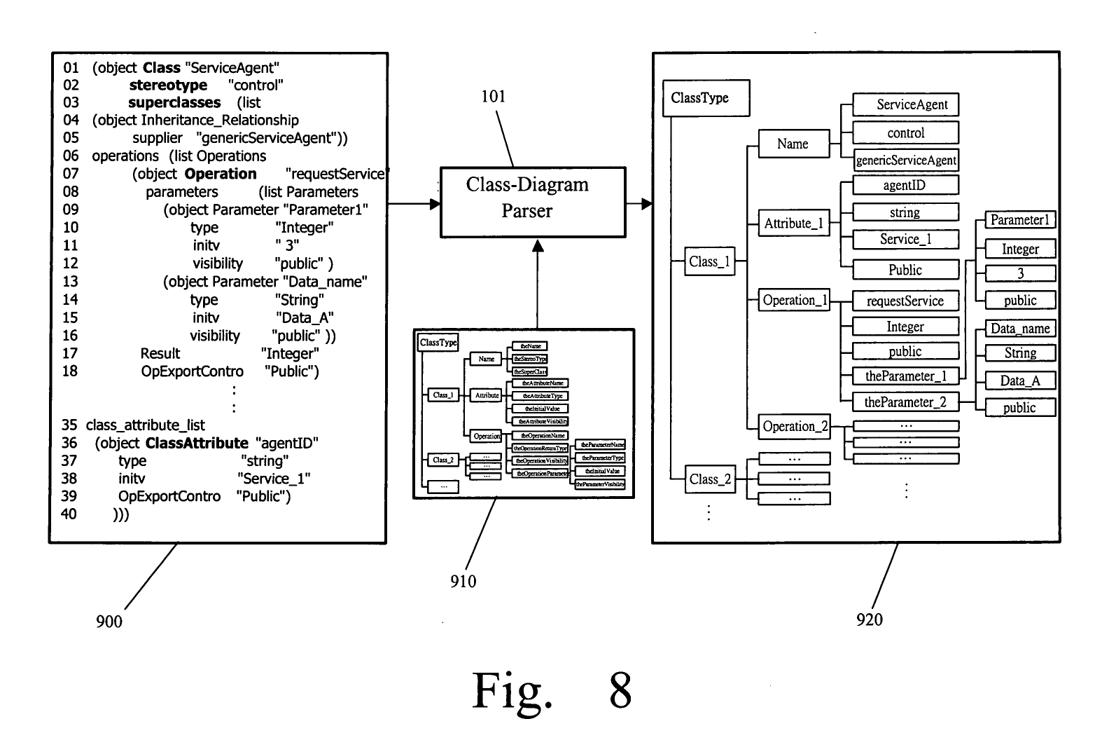

Referring to FIG. 8, FIG. 8 is a schematic diagram showing a procedure for parsing a file with an extension name “mdl” with a class diagram parser, according to the preferred embodiment of the present invention. Rational Rose UML model file 900 is the related document in mdl file of the ServiceAgent shown in FIG. 6. The class-diagram parser 101 refers to the class-diagram document structure 910 as shown in FIG. 4 to generate a class information diagram 920. With reference to an example designed, the detailed operation process is described as follows:

A Rational Rose UML Model file 900 contains data paragraphs related to the class of the ServiceAgent in the mdl file. According to the aforementioned parsing method, the class-diagram parser 101 first searches for all the classes in the mdl file with a key word, “object Class”, which stands for a class name, and then extracts the related data paragraphs. Such as shown in the paragraphs of FIG. 8, lines 1-5 record the information about the ServiceAgent: the class name (line 1), the stereotype (line 2) and the superclass (lines 3-5). The class name “ServiceAgent” (line 1) is parsed out and filled into field “theName” under the “Name” node with reference to the class-diagram document structure 910; the stereotype “control” (line 2) into field “theStereoType” under the “Name” node; the superclass “genericServiceAgent” (lines 3-5) into field “theSuperClass” of the “Name” node.

The class attribute “agentID” (Line 36) contains three attributes, “string”, “Service_{—}1”, and “Public” (Lines 37-39), and these three attributes are filled into four fields under the “Attribute_{—}1” node (such as shown in the class information diagram 920). Thereafter, the operation “requestService” (line 7) and two data “Integer” and “public” (lines 17-18) are parsed out and filled into three fields under the “Operation_{—}1” node. By the same token, the data related to two parameters “theParameter_{—}1” and “theParameter_{—}2” under the “Operation_{—}1” can also be filled in sequence.

(b) Process for Extracting Sequence Diagrams:

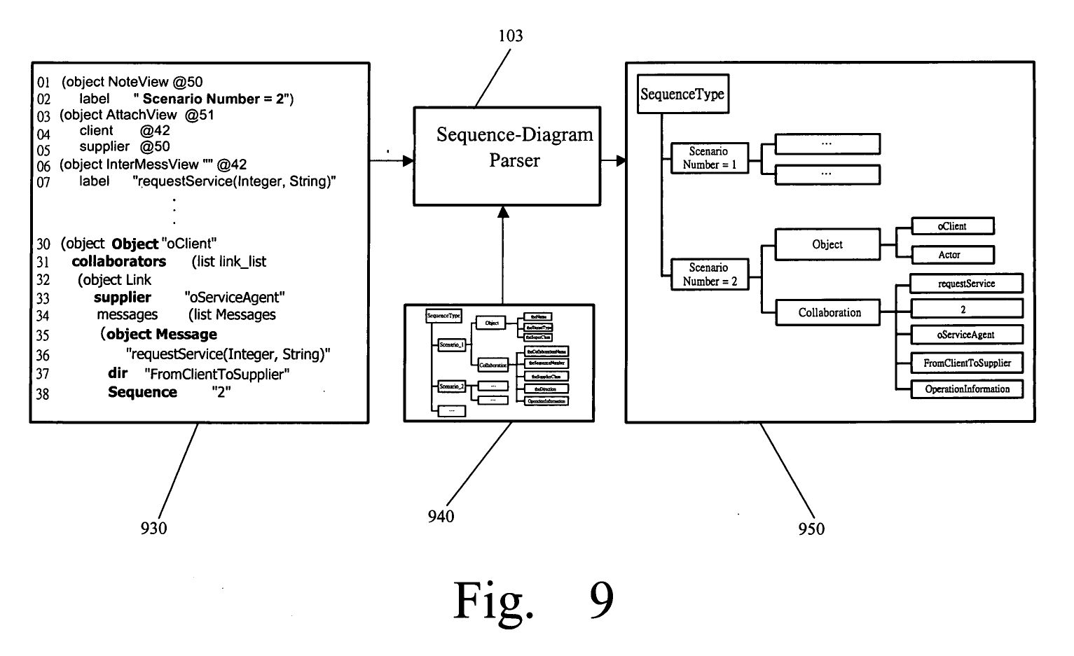

Referring to FIG. 9, FIG. 9 is a schematic diagram showing a procedure for parsing a file with an extension name “mdl” with a sequence diagram parser, according to the preferred embodiment of the present invention.

Rational Rose UML model file 930 is a portion of the data of the sequence diagram shown in FIG. 7 with the format of the mdl file. The sequence-diagram parser 103 refers to the sequence diagram document structure 940 as shown in FIG. 5 to generate a sequence information diagram 950. With reference to an example designed, the detailed operation process is described as follows.

For enabling the sequence-diagram parser 103 to recognize each scenario, field “Scenario_N” is added in the sequence-diagram document structure 940 so as to record the scenario number standing for a collaborative relationship, and meanwhile, the value existing in field “Scenario_N” represents that the collaborative relationship is a starting point of a scenario. On the other hand, the testing engineer uses the “Note” format defined by UML to add a note to the first collaborative relationship of each of the scenarios in sequence, and writes a string “Scenario Number=N” in the contents of the note, wherein “N” stands for the order of the scenario occurring in the sequence diagrams. The sequence-diagram parser 103 extracts the scenario number “Scenario Number_{—}2” (line 2) of the collaborative relationship and fills it into the “Scenario_N” field. The test-plan generator then edits the execution order of each of the collaborative relationships in the test plan.

Referring to the Rational Rose UML .mdl files 930 shown in FIG. 9, in the .mdl file, the sequence-diagram parser 103 searches for a string, “Scenario Number=2” (line 2), and learns that the string is located on a data paragraph starting with “(Object NoteView@50” (line 1), wherein “50” stands for the graphic number shown in the .mdl file, and the graphic number is unique which is not repeated as other graphic number. Then, based on number “50”, the sequence-diagram parser 103 searches for number “50+1”, i.e. a linkage at 51 (line 3), wherein the linkage depicts the reference linkage between the aforementioned note (@50) and the collaborative relationship (@42) (referring to FIG. 7). Lines 4 and 5 record the graphic numbers of both ends, i.e. @50 and @42, wherein @50 is the graphic number of the aforementioned note, and @42 is the collaborative relationship to be linked. Such as shown in FIG. 7, the relationship (@51) between client @42 and supplier @50 is a connection from @42 to @50. Hence, it can be known that the test execution point of the “Scenario Number” noted in the aforementioned note is the collaborative relationship labeled as @42 in the .mdl file, so that the information regarding the collaborative relationship can be found in the .mdl (line 6). Line 7: requestService(Integer, String) describes the operation method of the collaborative relationship, and then the data paragraph related the object of the operation method in the mdl file is parsed out in accordance with the operation method (line 30).

The parsed object: “oClient” (line 30) is filled into the name field under the object node, and the data about the stereotype field can be obtained from the class-diagram document structure. Further, since the object does not have any super class, the super class field does not need to be filled. The collaborative relationship between the object and another object, i.e. “requestService( )”, is built in the collaboration node, and the object message: “requestService”(lines 35, 36) is filled into field “theCollaborationName”; the sequence: “2” (line 38) is filled into field “the SequenceNumber”; the supplier: “oServiceAgent”(line 33) is filled into field “theSupplierClass”; and the dir: “FromClientToSupplier” (line 37) is filled into field “theDirection”. As to the information regarding field “OperationInformation”, it can be obtained by parsing the data related to ServiceAgent in the class-diagram document structure. When the test program performs the operation method requestService( ) in step 820, the operation methods queryData( ) in step 830 and processData( ) in step 840 are called sequentially and automatically, and then the result is returned back to the operation method requestService( ). Hence, the information for parsing step 830 and step 840 is not needed while the scenario is under test.

Step 2: Specifying Reference Input/Output Data

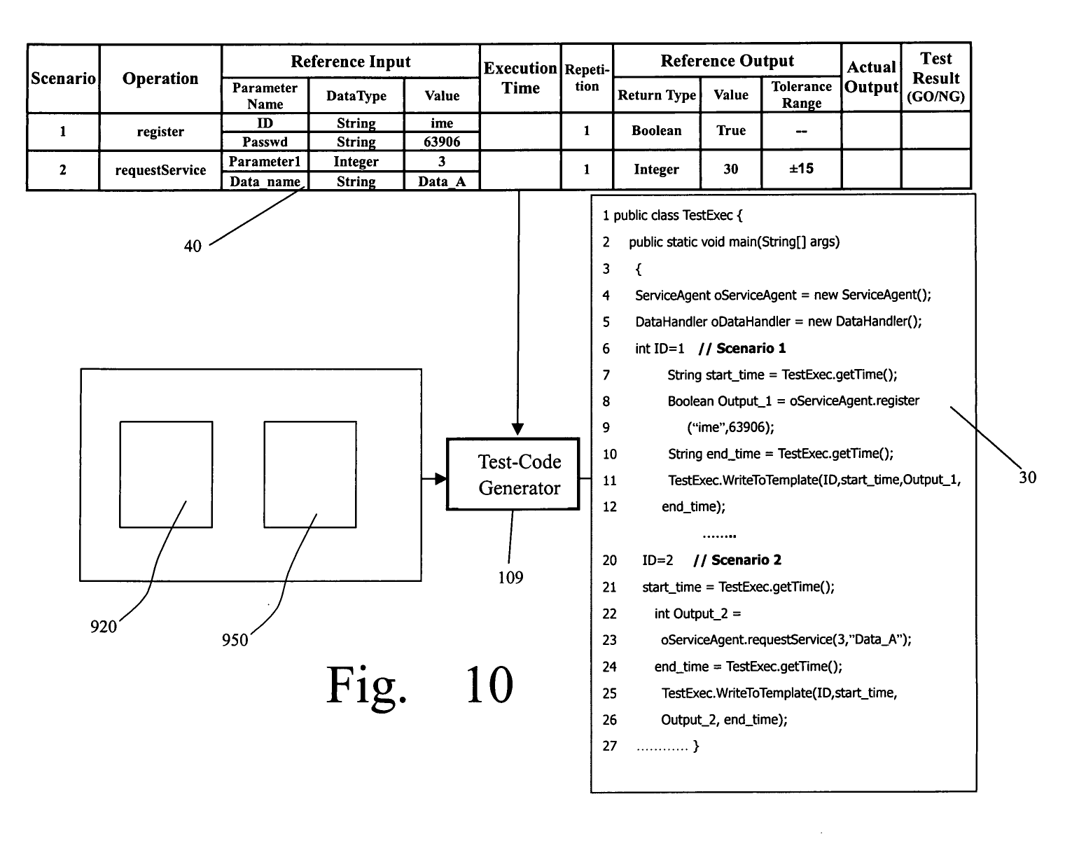

Referring to FIG. 10, FIG. 10 is a schematic diagram showing a test-result template containing reference input/output values of an illustrative example, according to the preferred embodiment of the present invention, wherein the test-plan codes are generated by the test-code generator 109. The test-code generator 109 fills the operation methods of the first scenario and the second scenario shown in FIG. 7 sequentially into the test-result template 40. In order to know what reference input data is required, the reference I/O editor 107 first seeks the required operation methods and the related input data in the class information diagram 920 as shown in FIG. 8 and the sequence information diagram 950 as shown in FIG. 9. For example, the operation method required in the first scenario (FIG. 7) is register( ) of which the class is genericServiceAgent; the parameter names are ID and Passwd; and the data type is string.

All the test-required input/output values are generated via the reference I/O editor 107, and displayed on the test-result template 40. Then, the testing engineer fills the reference values into the corresponding entries, for example, the reference input value of ID is “ime”; and the reference input value of password (“Passwd”) is “63906”. The testing engineer also fills the expected output result into the corresponding output entries, for example, the expected output type of register( ) is “Boolean”, and the value thereof is “True”. If the expected output type value is a numerical type, for example, the expected output type of register( ) is “integer”, then the tolerance range of the expected output value also can be entered, such as “±15”. Further, entry “Repetition” is designed in the test-result template 40 for the testing engineer to fill in the number of executing the test program. If the value entered is n, then the scenario will be executed n times.

Step 3: Generating Test-Plan Execution Codes

The test-plan execution codes 30 are divided into two groups. The first group is the connection codes responsible for connecting test-plan execution codes and the software under test. The second group is the test codes in charge of executing test plans to the software under test.

During the process for generating the test-plan execution codes 30, the test-code generator 109 knows that ServiceAgent and DataHandler are the classes of the software under test, so that the connection codes are created to declare the implementation objects of the classes for later testing programs (lines 4-5 of the test-plan execution codes 30 shown in FIG. 10). Thereafter, the test codes are created in accordance with each of the test steps. Such as lines 6-12 of the test-plan execution codes 30 shown, the test-code generator 109 firstly get the output type of the first scenario from the test-result template with reference I/O data. The output type describes that the return (output) data of register is in the type of Boolean. Thus, the test-code generator 109 creates the codes of Boolean Output_1 as shown in line 8.

It can be known that from the class information diagram 920 (see FIG. 8) shown in the left bottom of FIG. 10, the parent class of the operation register( ) is ServiceAgent, so that the object, oServiceAgent, built in line 4 is utilized to execute the operation and to fill the reference input data into the parameter values to complete the test codes of the function (Lines 8-9). The test-code generator 109 also creates the instructions for logging the time of the test-program execution (line 7: start_time=TestExec.getTime( ); and line 10: end_time=TestExec.getTime( )), thereby recording the execution time of the test codes. At last, the test-code generator 109 writes the data into the test-result template 40 (Lines 11-12). Similarly, the execution codes of the second scenario are also created in the same way.

Step 4: Analyzing Test Results

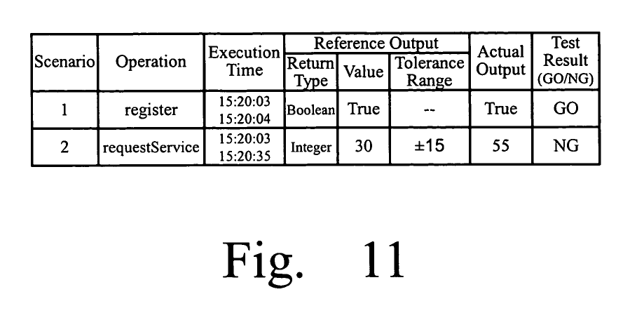

Referring to FIG. 11, FIG. 11 is a schematic diagram showing a test result of an illustrative example, according to the preferred embodiment of the present invention. After testing, the test codes fills the execution results into the test-result template 40 including execution time and actual outputs. Then, the comparator compares the actual outputs with the acceptable values provided by the reference outputs. If the actual output values are within the tolerable range, the test result will be “passed (GO)”; if not, the test fails (NG).

Further, the present invention can be provided for functional and non-functional tests. Since the reference input/output columns in the test-result template 40 can have different designs in accordance with various testing purposes, the content of each entry can be modified to accommodate various requirements of different tests. With respect to the software functional tests, the sequence diagrams are used as the test basis, and the attributes and operations in the class diagrams are used to set up the reference input/output data. With respect to the software non-functional tests, such as stress test and performance test, etc., the present invention can provide the test engineer to perform the non-functional tests by adding or modifying the entries in the test-result template, such as number of repeated executions, interval of repeated executions, and record of execution time, etc.; and designing the sequence diagrams to perform the desired test script.

Hence, an advantage of the present invention is to provide a generic software testing system and mechanism for performing a unit test and/or a system integration test that only need to refer to class diagrams (or interface definitions) and sequence diagrams, thereby the present invention can make test plans and perform the implementation of the system simultaneously. Therefore, as soon as the implementation of the system is done, the testing work can be performed immediately, thereby shortening the development life cycle of the entire software.

Another advantage of the present invention is to provide a generic software testing system and mechanism, wherein the present invention has generic applicability, and is suitable for use in various distributed object-oriented software industry and system integration industry, which can be any system as small as one single unit or module, or as large as the entire distributed object-oriented system as long as the functions and operations of the system can be expressed in the form of class diagrams (or interface definitions) and sequence diagrams. Therefore, the testing cost can be reduced, and the overall development efficiency can be increased.

Another advantage of the present invention is to provide generic software testing system and mechanism, not only for performing component (unit) tests but also for system tests. As long as the interfaces among components (units) can be clearly defined by using such as IDL (Interface Definition Language), then the present invention can be used for performing the related tests.

Another advantage of the present invention is to provide generic software testing system and mechanism for performing functional and non-functional tests.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A generic software testing system, provided for a distributed object-oriented system to perform a test, wherein said generic software testing system comprises:
a test-plan wizard, generating test-plan execution codes and a test-result template in accordance with class-diagram related data and sequence-diagram related data;
a tested software unit/system, executing said test plan execution codes to generate a test result; and
a comparator, comparing said test result with said test-result template to generate a test report.

2. The generic software testing system of claim 1, wherein said class-diagram related data comprises a plurality of I/O interface definitions, said I/O interface definitions defining I/O interfaces of a plurality of modules in said distributed object-oriented system.

3. The generic software testing system of claim 1, wherein said class-diagram related data comprises a plurality of class diagrams.

4. The generic software testing system of claim 3, wherein said class diagram are generated by development tools using UML (Unified Model Language).

5. The generic software testing system of claim 1, wherein said sequence-diagram related data comprises a testing sequence diagram, and said testing sequence diagram is selected from a plurality of sequence diagrams.

6. The generic software testing system of claim 5, wherein said sequence diagram are generated by development tools using UML.

7. The generic software testing system of claim 1, wherein said test-plan wizard comprises:
a class-diagram parser, used for parsing said class-diagram related data so as to obtain a class information diagram;
a sequence-diagram parser, used for parsing said sequence-diagram related data so as to obtain a sequence information diagram;
a test-plan generator, generating a test plan in accordance with said class information diagram, said sequence information diagram and a plurality of scenarios in said sequence information diagram;
a reference I/O editor, wherein said reference I/O editor generates an input/output interface so as to input a plurality of reference input values and a plurality of reference output values, and then builds a test-result template in accordance with said test plan, said reference input values and said reference output values; and
a test-code generator, generating said test codes in accordance with said test plan and said reference input values.

8. The generic software testing system of claim 1, wherein said distributed object-oriented system is composed of a plurality of units, and said class-diagram related data is the data of interface definition diagram for said units, and said sequence-diagram related data is the data of relationship diagram among said units.

9. The generic software testing system of claim 8, wherein said distributed object-oriented system uses CORBA (Common Object Request Broker Architecture) as the communication fundamental structure, and an IDL (Interface Definition Language) file is used for showing the data of interface definition diagram of said units, and the data of relationship diagram among said units.

10. The generic software testing system of claim 9, wherein said test-result template comprises a plurality of entries used for said distributed object-oriented system to perform non-functional tests.

11. The generic software testing system of claim 9, wherein said entries further comprises a first entry for showing the number of repeated executions, a second entry for showing the interval of repeated executions, and a third entry for showing the record of execution time.

12. A generic software testing mechanism, used for a distributed object-oriented system to perform a test, wherein said generic software testing mechanism comprises:
inputting class-diagram related data to a test-plan wizard as a basis of said test;
selecting a testing sequence diagram from sequence-diagram related data for use in said test, and inputting the data of said testing sequence diagram to said test-plan wizard;
filling a plurality of reference input values and a plurality of output values with respect to said testing sequence diagram;
generating a test-result template containing said reference input values and said reference output values by said test-plan wizard;
passing said test-result template to a comparator;
generating test-plan execution codes by said test-plan wizard;
executing said test-plan execution codes by a tested software unit/system for performing said test so as to generate a test result, wherein said tested software unit/system is corresponding to said class-diagram related data and said sequence-diagram related data;
passing said test result to said comparator; and
creating a test report by said comparator.

13. The generic software testing mechanism of claim 12, wherein said class-diagram related data comprises a plurality of I/O interface definitions, said I/O interface definitions defining I/O interfaces of a plurality of modules in said distributed object-oriented system.

14. The generic software testing mechanism of claim 12, wherein said class-diagram related data comprises a plurality of class diagrams.

15. The generic software testing mechanism of claim 14, wherein said class diagram are generated by development tools using UML.

16. The generic software testing mechanism of claim 12, wherein said testing sequence diagram is selected from a plurality of sequence diagrams.

17. The generic software testing mechanism of claim 16, wherein said sequence diagram are generated by development tools using UML.

18. The generic software testing mechanism of claim 12, further comprising:
parsing said class-diagram related diagram by a class-diagram parser of said test-plan wizard, so as to obtain a class information diagram;
parsing said sequence-diagram related diagram by a sequence-diagram parser of said test-plan wizard, so as to obtain a sequence information diagram;
generating a test plan by a test-plan generator of said test-plan wizard in accordance with said class information diagram, said sequence information diagram and a plurality of scenarios in said sequence information diagram;
generating an input/output interface by a reference I/O editor of said test-plan wizard, so as to input a plurality of reference input values and a plurality of reference output values.
building a test-result template by said reference I/O editor in accordance with said test plan, said reference input values and said reference output values; and
generating said test codes by a test-code generator of said test-plan wizard in accordance with said test plan and said reference input values.

19. The generic software testing mechanism of claim 12, wherein said distributed object-oriented system is composed of a plurality of units, and said class-diagram related data is the data of interface definition diagram for said units, and said sequence-diagram related data is the data of relationship diagram among said units.

20. The generic software testing mechanism of claim 19, wherein said distributed object-oriented system uses CORBA as the communication fundamental structure, and an IDL file is used for showing the data of interface definition diagram of said units, and the data of relationship diagram among said units.

21. The generic software testing mechanism of claim 20, wherein said test-result template comprises a plurality of entries used for said distributed object-oriented system to perform non-functional tests.

22. The generic software testing mechanism of claim 21, wherein said entries further comprises a first entry for showing the number of repeated executions, a second entry for showing the interval of repeated executions, and a third entry for showing the record of execution time.
